(19) United States
(12) Patent Application Publication
(10) Pub. No.: US 2009/0145319 A1
(43) Pub. Date: Jun. 11, 2009

(54) Apparatus for Transporting a Printing Plate to or From a Plate Cylinder of a Printing Press and Printing Unit and Printing Press Having the Apparatus

(75) Inventors: Martin Greive, Schriesheim (DE); Rolf Kundgen, Bad Schonborn (DE); Gerd Merkel, Dielheim (DE); Rudi Stellberger, Kronau (DE); Mathias Zuber, Helmstadt-Bargen (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AG, Heidelberg (DE)

(21) Appl. No.: 12/329,958

(22) Filed: Dec. 8, 2008

(30) Foreign Application Priority Data
Dec. 7, 2007 (DE) 10 2007 058 958.3

(51) Int. Cl. B41F 27/12

(52) U.S. Cl. 101/477

(57) ABSTRACT

An apparatus for transporting a printing plate to or from a plate cylinder of a printing press includes a first, driven transport roller that is stationarily disposed and a second transport roller that is disposed so as to be movable in the direction of the first transport roller. The second transport roller is mounted so as to be pivotable about a pivot axis disposed perpendicularly to its axis of rotation, preferably by a ball and socket joint or a fork bearing.

### CROSS-REFERENCE TO RELATED APPLICATION

This application claims the priority, under 35 U.S.C. § 119, of German Patent Application DE 10 2007 058 958.3, filed Dec. 7, 2007; the prior application is herewith incorporated by reference in its entirety.

### BACKGROUND OF THE INVENTION

### Field of the Invention

The invention relates to an apparatus for transporting a printing plate to or from a plate cylinder of a printing press by a stationarily disposed first transport roller and a second transport roller disposed so as to be pivotable in the direction of the first transport roller, in which one of the transport rollers is mounted so as to be movable parallel to the axis of the plate cylinder. The invention also relates to a printing unit and a printing press having the apparatus.

An apparatus of that type is disclosed in European Patent EP 0 667 237 B1. A rotatably driven transport roller that is able to be brought into active contact with a rotatably mounted and stationarily disposed back-pressure or impression-pressure roller, is shown therein. A drive axle of the transport roller and the back-pressure roller are mounted so as to be axially movable.

### SUMMARY OF THE INVENTION

It is accordingly an object of the invention to provide an alternative apparatus for transporting a printing plate to or from a plate cylinder of a printing press and a printing unit and a printing press having the apparatus, which overcome the hereinafore-mentioned disadvantages of the heretofore-known devices of this general type.

With the foregoing and other objects in view, there is provided, in accordance with the invention, an apparatus for transporting a printing plate to or from a plate cylinder of a printing press. The apparatus comprises a first, driven transport roller and a second transport roller disposed so as to be movable in the direction of the first transport roller. The first, driven transport roller is stationarily disposed, and the second transport roller is rotatably disposed and is disposed so as to be pivotable about a pivot axis disposed vertically with respect to an axis of rotation thereof.

In accordance with another feature of the invention, the apparatus further includes a ball and socket joint by which the second transport roller is mounted on the axis of rotation thereof.

In accordance with a further feature of the invention, the second transport roller is supported in a laterally sprung manner.

In accordance with an added feature of the invention, the apparatus further includes a fork bearing wherein the second transport roller is disposed.

In accordance with an additional feature of the invention, the fork bearing is disposed so as to be pivotable about the pivot axis.

In accordance with yet another feature of the invention, the second transport roller is pivotable about a pivot axis so as to be settable against the first transport roller.

With the objects of the invention in view, there is also provided a printing unit of a sheet-fed printing press having an apparatus according to the invention.

With the objects of the invention in view, there is concomitantly provided a sheet-fed rotary printing press having an apparatus according to the invention.

It is a particular advantage of the invention that the drive roller is stationarily disposed and that the back-pressure roller is disposed so that it is pivotable against the stationarily disposed drive roller. As a result of this measure, the drive for the drive roller can be disposed to be stationary, for example on the printing plate changing apparatus.

The back-pressure roller is fixed on an axle disposed parallel to the drive axis of the drive roller and is able to execute small pivoting movements with respect to the center thereof. Due to this measure, the back-pressure roller is able to roll on the printing plate transversely to the transport direction of the latter, if the printing plate executes a lateral movement, for example, when being introduced into register pins that are provided. Due to rolling of the back-pressure roller on the printing plate, a braking force on the printing plate is kept very low.

In a second exemplary embodiment, the back-pressure roller is disposed in a fork bearing which is fixed to an axle disposed parallel to the drive axis of the drive roller. The fork bearing has a pivot axis about which the back-pressure roller can execute small pivoting movements. The pivot axis and the axle are disposed perpendicularly to one another.

Other features which are considered as characteristic for the invention are set forth in the appended claims.

Although the invention is illustrated and described herein as embodied in an apparatus for transporting a printing plate to or from a plate cylinder of a printing press and a printing unit and a printing press having the apparatus, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, longitudinal-sectional view of a sheet-fed rotary printing press;

FIG. 2 is an enlarged, fragmentary, longitudinal-sectional view of printing units of the sheet-fed rotary press;

FIG. 3 is a further enlarged, fragmentary, sectional view showing transport rollers according to the invention;

FIG. 4 is an enlarged, fragmentary, longitudinal-sectional view of the transport rollers;

FIG. 5 is another sectional view of a back-pressure roller according to the invention;

FIG. 6 is a sectional view, reduced in size, of a second exemplary embodiment of the transport rollers; and

FIG. 7 is a fragmentary, perspective view of the transport rollers of the second exemplary embodiment.

### DETAILED DESCRIPTION OF THE INVENTION

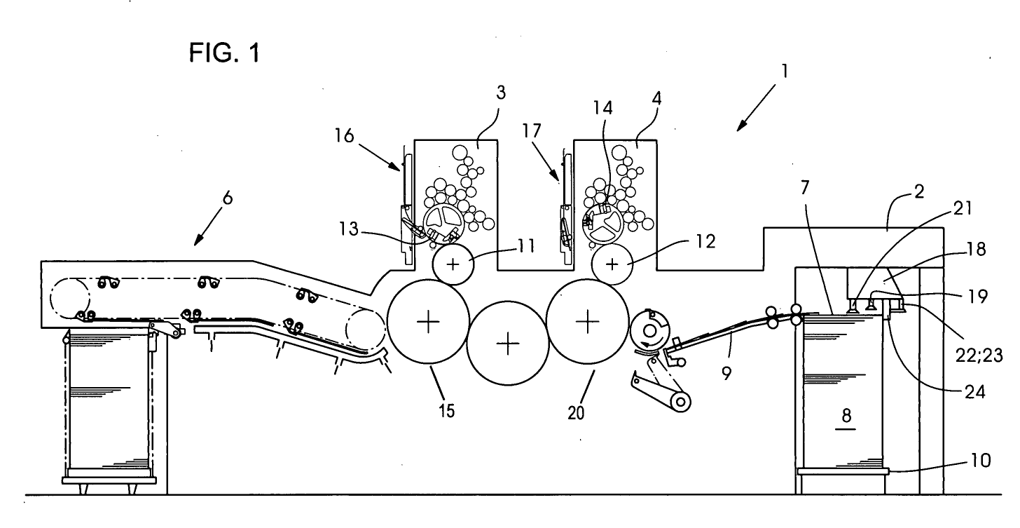

Referring now to the figures of the drawings in detail and first, particularly, to FIG. 1 thereof, there is seen a machine for processing sheets 7, for example a printing press 1 having a sheet feeder 2, at least one printing unit 3 and 4 and a delivery 6. The sheets 7 are removed from a sheet pile or stack 8 and, either separated or disposed in overlapping formation, are fed over a feed table 9 to the printing units 3 and 4. The latter respectively include, in a conventional manner, a plate cylinder 11, 12 and blanket cylinders 15 and 20, respectively interacting therewith. The plate cylinders 11 and 12 have respective clamping devices 13, 14 for fixing flexible printing plates thereon. Furthermore, an apparatus 16, 17 for semi-automatically or fully automatically changing the printing plates is assigned to each respective plate cylinder 11, 12.

The sheet stack or pile 8 rests on a stack or pile board 10 which is controllably liftable. The sheets 7 are removed from the top side of the sheet stack 8 by a so-called suction head 18 which, amongst other devices, has a number of lifting and dragging suckers 19, 21 for individually separating the sheets 7. Moreover, blowing devices 22 are provided for loosening the upper sheet layers, and sensing elements 23 for stack or pile tracking. A number of lateral and rear stops 24 are provided in order to align the sheet pile or stack 8, in particular, the upper sheets 7 of the sheet pile or stack 8.

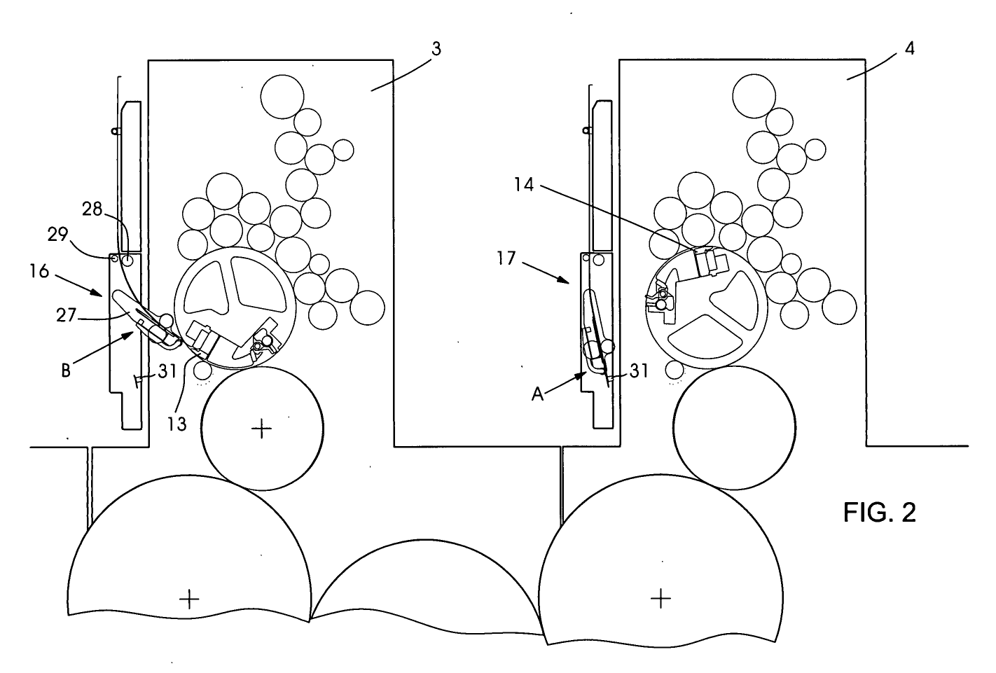

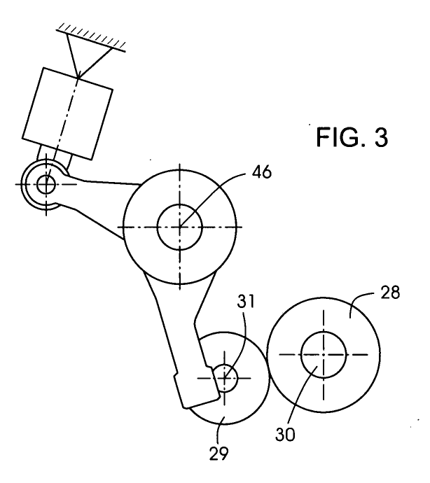

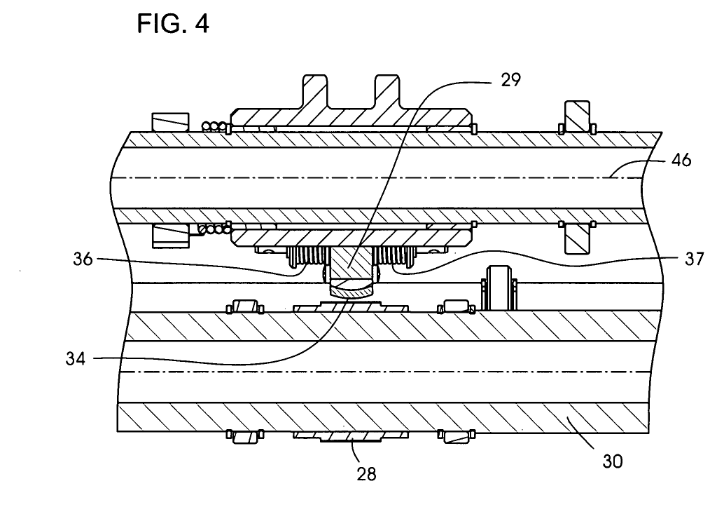

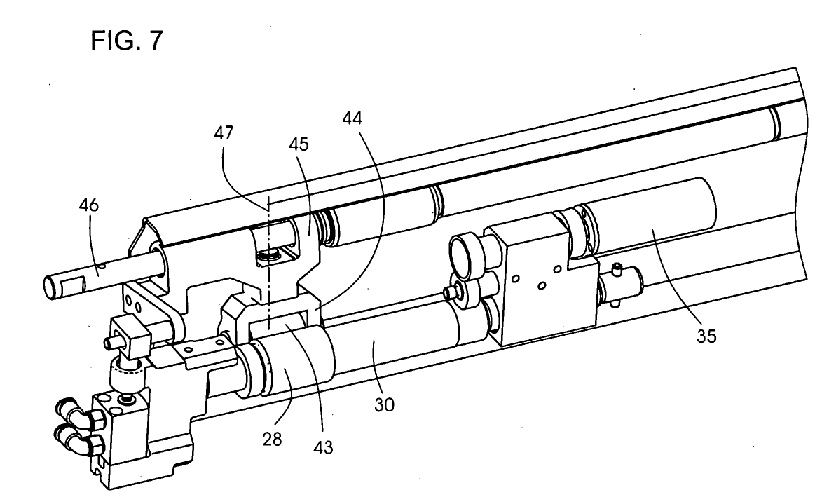

As is shown more clearly in FIG. 2, the respective printing plate changing apparatus 16, 17 has a pivotable guiding device 27 and two cooperating transport rollers 28 and 29. The transport roller 28 is stationarily disposed on the printing plate changer 16 as a drive roller and is provided with a drive 35 seen in FIG. 7. The drive roller 28, as is further shown in FIG. 7, is disposed on a shaft 30 that is displaceable counter to a spring force. As is shown in FIGS. 3 and 4, the transport roller 29 is disposed so as to be pivotable as a back-pressure roller and can be brought into active contact with the drive roller 28.

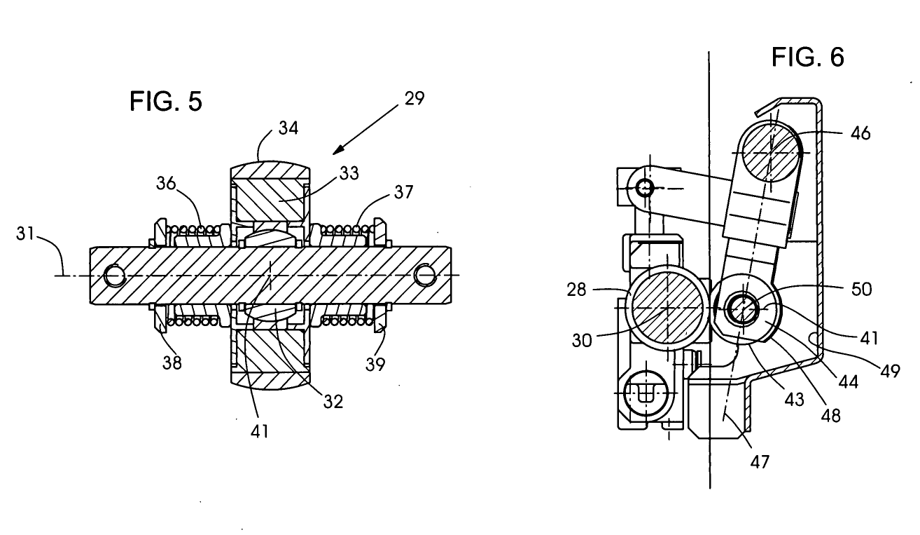

FIG. 5 is a sectional view taken through the cambered backing or back-pressure roller 29. The latter has a ball-and-socket joint 32, which is cambered on the periphery thereof, and is disposed about a rotational axis 31 of the roller 29. A roller element 33 is rotatably mounted on this periphery. The roller element 33 is formed with a cambered running surface 34, preferably formed of rubber. The roller element 33 is laterally supported by two compression springs 36 and 37. The respective compression springs 36 and 37 surround the axis 31 coaxially and are each supported on a respective abutment 38, 39 which is fixed about the axis 31.

The roller element 33 is mounted on the ball and socket joint 32 so as to be pivotable through a small angle counter to the force of the compression springs 36 and 37. Due to this measure, the backing roller 29, which is in contact with a printing plate by the running surface 34, is pivotable about a pivot axis 41. The pivot axis 41 intersects the axis 31 at the bearing point of the backing roller 29 at a right angle.

In a second exemplary embodiment shown in FIGS. 6 and 7, a cambered back-pressure roller 43 is rotatably mounted in a fork bearing 44. The back-pressure roller 43 interacts with the drive roller 28 in exactly the same manner as in the first exemplary embodiment. The fork bearing 44 is fixed by a holder 45 to a pivot shaft 46 disposed parallel to the shaft 30 and the drive roller 28. The fork bearing 44 is fixed to the holder 45 by a ball and socket joint, so that the fork bearing 44 is pivotable about a pivot axis 47 extending perpendicularly to the shaft 46.

During contact with a printing plate, the back-pressure roller 43 rolls on the surface of the printing plate in the transport direction thereof. If the printing plate is displaced laterally or sideways, the cambered back-pressure roller 43 pivots about the perpendicularly disposed pivot axis 47, so that the latter also executes a rolling movement in the lateral direction. Due to this measure or feature, a braking action of the back-pressure roller 43 on the printing plate is minimized.

In order to set the back-pressure roller 43 back following a pivoting movement, it is pivoted away, together with the fork bearing 44, from the drive roller 28 about the pivot axis 46, until a stop 48 on the fork bearing 44 strikes a rear wall 49. Due to this measure or feature, the fork bearing 44 and, accordingly, the back-pressure roller 43, are set back into the initial position thereof.

1. An apparatus for transporting a printing plate to or from a plate cylinder of a printing press, the apparatus comprising:
a first, driven transport roller and a second transport roller disposed so as to be movable in direction of said first transport roller;
said first, driven transport roller being stationarily disposed; and
said second transport roller being rotatably disposed and being disposed so as to be pivotable about a pivot axis disposed vertically with respect to an axis of rotation of said second transport roller.

2. The apparatus according to claim 1, which further comprises a ball and socket joint mounting said second transport roller about said axis of rotation of said second transport roller.

3. The apparatus according to claim 2, wherein said second transport roller is supported in a laterally sprung manner.

4. The apparatus according to claim 1, which further comprises a fork bearing in which said second transport roller is disposed.

5. The apparatus according to claim 4, wherein said fork bearing is pivotable about said pivot axis.

6. The apparatus according to claim 1, wherein said second transport roller is pivotable about said pivot axis and can be set against said first transport roller.

7. A printing unit of a sheet-fed printing press, comprising an apparatus according to claim 1.

8. A sheet-fed rotary printing press, comprising an apparatus according to claim 1.
